(19) United States
(12) Patent Application Publication
(10) Pub. No.: US 2009/0025397 A1
(43) Pub. Date: Jan. 29, 2009

(54) Method of Optimizing the Energy of a Site Comprising a Cogeneration System and a Thermal Power Plant

(75) Inventor: Tanguy POLINE, Sucy-En-Brie (FR)

Correspondence Address: AIR LIQUIDE;Intellectual Property, 2700 POST OAK BOULEVARD, SUITE 1800, HOUSTON, TX, 77056, US

(73) Assignee: L'Air Liquide Societe Anonyme Pour L'Etude Et L'Exloitation Des Procedes Georges Claude, Paris (FR)

(21) Appl. No.: 12/020,051

(22) Filed: Jan. 25, 2008

(30) Foreign Application Priority Data
Jan. 25, 2007 (FR) 0752875

(51) Int. Cl. F02C 7/00

(52) U.S. Cl. 60/783; 60/784; 60/39.5; 165/104.28

(57) ABSTRACT

The invention relates to a method of generating power and heat, employing:
a cogeneration system comprising:
   a gas turbine generating power and combustion gases and
   a heat recovery unit fed with water and heating said water by recovering the heat from the combustion gases coming from the gas turbine; and
a thermal power plant fed with water preheated by a degasifier, said degasifier being fed with cold water at a temperature below the temperature of the water feeding the heat recovery unit of the cogeneration system,
   and in which the cold water feeding the degasifier of the thermal power plant, before being preheated by the degasifier, is preheated by heat exchange with the water feeding the heat recovery unit of the cogeneration system.

### CROSS REFERENCE TO RELATED APPLICATIONS

This application claims the benefit of priority under 35 U.S.C. § 119(a) and (b) to French Application No. 0752875, filed Jan. 25, 2007, the entire contents of which are incorporated herein by reference.

The present invention relates to a method of optimizing the energy of a combined heat and power generation site employing a cogeneration system and a thermal power plant.

Large industrial sites use basic commodities, namely, on the one hand, mechanical or electrical power and, on the other hand, heat (steam or hot water). On many sites, these commodities are produced by cogeneration systems and thermal power plants.

The object of the present invention is to propose the integration of a cogeneration line with a heat recovery boiler and a neighbouring thermal power plant so as to optimize the overall energy efficiency.

For this purpose, the invention relates to a method of generating power and heat, employing:
a cogeneration system comprising:
   a gas turbine generating power and combustion gases and
   a heat recovery unit fed with water and heating said water by recovering the heat from the combustion gases coming from the gas turbine; and
a thermal power plant fed with water preheated by a degasifier, said degasifier being fed with cold water at a temperature below the temperature of the water feeding the heat recovery unit of the cogeneration system,
   and in which the cold water feeding the degasifier of the thermal power plant, before being preheated by the degasifier, is preheated by heat exchange with the water feeding the heat recovery unit of the cogeneration system.

The invention therefore relates to a method employed on an industrial site that comprises at least one cogeneration system. The cogeneration system comprises a gas turbine producing mechanical or electrical energy by the expansion of combustion gases. The heat of these combustion gases is recovered in a heat recovery unit intended to produce steam or hot water. This heat recovery unit is generally a boiler in which the heat of the combustion gases coming from the gas turbine heats the water introduced into the boiler. The combustion gases coming from the turbine may also be used as oxidizer if they still contain oxygen and if a fuel is introduced into the heat recovery unit—this is then referred to as post-combustion. In general, the heat recovery unit is fed with water that is already hot—the term “hot water” is understood to mean water having a temperature of at least 105° C.

On the industrial site, there is also a thermal power plant. The term “thermal power plant” is understood to mean any means of producing heat in the form of hot water or steam by heating water by burning a fuel with an oxidizer. This is in general a boiler. This boiler may be independent—this is the case of the boiler of a steam production unit—or it may be connected with another process—this is the case of the heat recovery unit of a cogeneration system. The thermal power plant is fed with water preheated by a degasifier. The degasifier brings the water to be preheated into contact with steam so as to preheat the water and at the same time eliminate the oxygen dissolved in this water. The degasifier uses steam that may be derived from the steam produced by the heat recovery unit of the cogeneration system or by the thermal power plant. According to the invention, the degasifier of the thermal power plant is fed with cold water at a temperature below the temperature of the water feeding the heat recovery unit of the cogeneration system. According to the invention, it is preferable for the temperature of the cold water feeding the degasifier of the thermal power plant to be at least 10° C., preferably at least 20° C., below the temperature of the water feeding the heat recovery unit of the cogeneration system.

According to the method of the invention, the cold water feeding the degasifier is preheated by heat exchange with the water feeding the heat recovery unit of the cogeneration system.

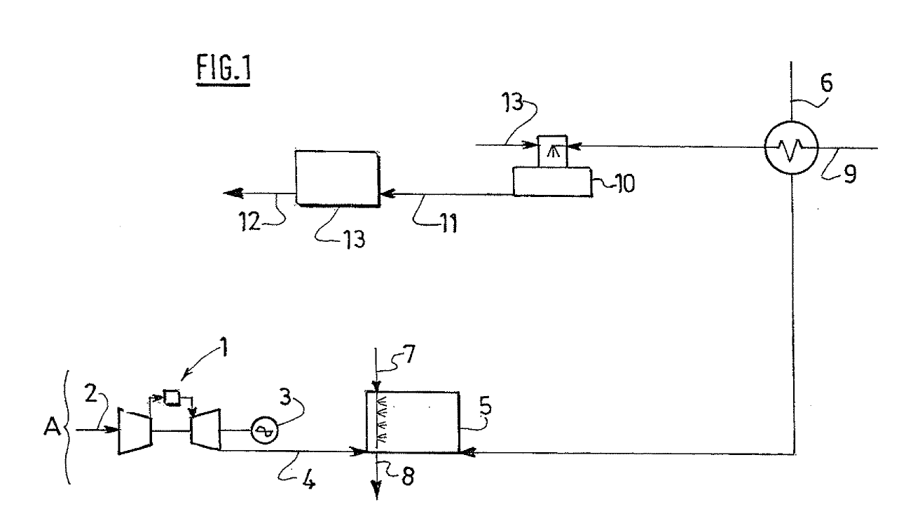

The invention is illustrated by FIG. 1.

The industrial site illustrated comprises a cogeneration system A made up of:
a gas turbine 1 fed with a fuel 2 and producing mechanical or electrical energy 3 and hot combustion gases 4; and
heat recovery unit 5 that recovers the heat of the combustion gases 4 in order to vaporize hot water 6. This hot water 6 is also vaporized in the heat recovery unit 5 by burning a fuel 7 with the oxygen that remains in the combustion gases 4. The heat recovery unit 5 produces steam 8.

The site also comprises a thermal power plant B fed with hot water 11 so as to produce steam 12. The hot water 11 is obtained in succession by:
heating, by heat exchange between, on the one hand, the cold water 9 of the thermal power plant, and, on the other hand, the hot water 6 that feeds the heat recovery unit; and then
heating this already preheated water 9 in a degasifier 10 fed with steam 13.

The steam 13 used in the degasifier 10 for heating the cold water 9 of the thermal power plant B is preferably low-pressure or medium-pressure steam derived from the high-pressure steam 12 and 8 produced by the heat recovery unit 5 and the thermal power plant B.

The method according to the invention makes it possible to reduce the steam consumption of the degasifier needed to heat the cold water of the thermal power plant by recovering the heat from the hot water intended for feeding the heat recovery unit of the cogeneration system. At the same time, only a very slight drop in steam production by the heat recovery unit of the cogeneration system is observed.

The invention has been implemented on an industrial site reproducing the scheme shown in FIG. 1. The temperature of the water intended to be introduced into the heat recovery unit of the cogeneration system was 148° C. and the temperature of the cold water intended to be introduced into the degasifier of the thermal power plant was 81° C. Heat exchange between these two fluids was carried out so as to bring the temperature of the cold water intended to be introduced into the degasifier of the thermal power plant to 114° C. and the temperature of the water intended to be introduced into the heat recovery unit of the cogeneration system to 88° C. By preheating the cold water intended to be introduced into the degasifier of the thermal power plant, it was possible to save 12 t/h of steam at 4 bar pressure for heating this water. On the down side, the heat recovery unit of the cogeneration system experienced a drop in its high-pressure steam production from 105 t/h to only 103.5 t/h.

It will be understood that many additional changes in the details, materials, steps and arrangement of parts, which have been herein described in order to explain the nature of the invention, may be made by those skilled in the art within the principle and scope of the invention as expressed in the appended claims. Thus, the present invention is not intended to be limited to the specific embodiments in the examples given above.

What is claimed is:

1. A method of generating power and heat, employing:
a cogeneration system comprising:
a gas turbine generating power and combustion gases and
a heat recovery unit fed with water and heating said water by recovering the heat from the combustion gases coming from the gas turbine; and
a thermal power plant fed with water preheated by a degasifier, said degasifier being fed with cold water at a temperature below the temperature of the water feeding the heat recovery unit of the cogeneration system,
and in which the cold water feeding the degasifier of the thermal power plant, before being preheated by the degasifier, is preheated by heat exchange with the water feeding the heat recovery unit of the cogeneration system.

2. The method of claim 1, characterized in that the temperature of the cold water feeding the degasifier of the thermal power plant is at least 10° C. below the temperature of the water feeding the heat recovery unit of the cogeneration system.

3. The Method of claim 1, characterized in that the degasifier uses steam derived from the steam produced by the heat recovery unit of the cogeneration system or by the thermal power plant.
